(19) United States
(12) Patent Application Publication
(10) Pub. No.: US 2007/0116996 A1
(43) Pub. Date: May 24, 2007

(54) Regenerative fuel cell/electrolyzer stack

(75) Inventors: Thomas J. Pavlik, Riviera Beach, FL (US); James C. Braun, Boynton Beach, FL (US)

Correspondence Address: KIRKPATRICK & LOCKHART PRESTON GATES ELLIS LLP, 535 SMITHFIELD STREET, PITTSBURGH, PA, 15222, US

(73) Assignee: Teledyne Technologies Incorporated

(21) Appl. No.: 11/329,904

(22) Filed: Jan. 11, 2006

Related U.S. Application Data
(60) Provisional application No. 60/738,738, filed on Nov. 22, 2005.

(51) Int. Cl. H01M 8/18; H01M 8/24; H01M 8/10; H01M 8/04

(52) U.S. Cl. 429/21; 429/38; 429/32; 429/33; 429/22; 429/34

(57) ABSTRACT

A regenerative fuel cell/electrolyzer stack. The regenerative fuel cell/electrolyzer stack may comprise a fuel cell electrode assembly comprising first and second fuel cell electrodes, as well as a fuel cell electrolyte. The regenerative fuel cell/electrolyzer stack may also comprise an an electrolyzer electrode assembly comprising first and second electrolyzer electrodes. A conductive plate may be positioned between the fuel cell electrode assembly and the electrolyzer electrode assembly. The conductive plate may comprise a first surface facing the first fuel cell electrode and a second surface facing the first electrolyzer electrode. The first surface may comprise at least one flow path open to the first fuel cell electrode, and the second surface may comprise at least one flow path open to the first electrolyzer electrode.

This application claims the benefit of U.S. Provisional Application No. 60/738,738, filed on Nov. 22, 2005.

### BACKGROUND

Fuel cells are clean and efficient sources of electricity used today in applications ranging from cell phones to space vehicles. A fuel cell generates electricity by chemically combining two or more reactant substances to produce an electric current and a chemical product. Many fuel cell designs utilize hydrogen (H₂) and oxygen (O₂) as reactant substances, with water (H₂O) as the primary product.

Fuel cells are also sometimes used in conjunction with electrolyzers to form regenerative fuel cell systems. In a reaction that is the reverse of such fuel cell reactions, electrolyzers split water into hydrogen and oxygen when an electric current is provided. Regenerative fuel cell systems have the functionality of both fuel cells and electrolyzers, and may produce power or reactants in different operational modes. In an electrolyzer mode, regenerative systems act as an electrolyzers, utilizing an external source of power, such as a power grid or solar cell to split water into hydrogen and oxygen. In a fuel cell mode, the regenerative system acts as a fuel cell, recombining the hydrogen and oxygen generated in the electrolyzer mode to generate electricity.

Existing designs for regenerative fuel cell systems have significant disadvantages in size and efficiency. For example, one regenerative fuel cell design requires that the same cells be used for both electrolysis and fuel cell reactions. Because the cells must operate in both electrolyzer and fuel cell modes, it is difficult to optimize them for both. As a result, the overall efficiency of such a regenerative system suffers compared to stand alone electrolyzer and fuel cells. Another common regenerative system design includes a first stack of cells used exclusively for fuel cell operation, and a second stack of cells used exclusively for electrolysis. Although this design allows optimization for the different cell types and provides greater efficiency compared to single cell set designs, such a design adds significant size and bulk to the system as two stacks of cells must be included.

### SUMMARY

According to one general aspect, the present invention is directed to a regenerative fuel cell/electrolyzer stack. The regenerative fuel cell/electrolyzer stack may comprise, according to various embodiments, a fuel cell electrode assembly comprising first and second fuel cell electrodes, as well as a fuel cell electrolyte. The regenerative fuel cell/electrolyzer stack may also comprise an electrolyzer electrode assembly, with the electrolyzer electrode assembly comprising first and second electrolyzer electrodes. A conductive plate may be positioned between the fuel cell electrode assembly and the electrolyzer electrode assembly. The conductive plate may comprise a first surface facing the first fuel cell electrode and a second surface facing the first electrolyzer electrode. The first surface may comprise at least one flow path open to the first fuel cell electrode, and the second surface may comprise at least one flow path open to the first electrolyzer electrode.

According to another general aspect, the present invention is directed to a method of operating a regenerative fuel cell/electrolyzer stack. The regenerative fuel cell/electrolyzer stack may comprise a fuel cell electrode assembly. The fuel cell electrode assembly may comprise a fuel cell cathode, a fuel cell anode and a fuel cell electrolyte. The regenerative fuel cell/electrolyzer stack may also comprise an electrolyzer electrode assembly. The electrolyzer electrode assembly may comprise an electrolyzer cathode and an electrolyzer anode. A first conductive plate may be positioned between the fuel cell electrode assembly and the electrolyzer electrode assembly. A second conductive plate may be positioned opposite the fuel cell electrode assembly from the first conductive plate. Also, a third conductive plate may be positioned opposite the electrolyzer electrode assembly from the first conductive plate. The method may comprise, according to various embodiments, the step of providing an electrical connection between the first and third conductive plates. The method may also comprise the steps of providing a hydrogen-containing substance to the fuel cell anode via a fuel cell anode flow path in the first conductive plate, and providing an oxygen-containing substance to the fuel cell cathode via a fuel cell cathode flow path in the second conductive plate. In various embodiments, the method may also comprise the step of providing a coolant via a second flow path in the first conductive plate and a first flow path in the third conductive plate.

According to yet another general aspect, the present invention is directed to a regenerative fuel cell system. The system may comprise a plurality of fuel cell electrode assemblies, a plurality of electrolyzer electrode assemblies and a plurality of conductive plates. The plurality of electrolyzer electrode assemblies may be positioned such that at least a portion of the electrolyzer electrode assemblies and at least a portion of the fuel cell electrode assemblies are interleaved. Also, the plurality of conductive plates may be positioned between one of the plurality of fuel cell electrode assemblies and one of the plurality of electrolyzer electrode assemblies. The system may also comprise a switching network comprising a plurality of switches coupled to the plurality of conductive plates and a control circuit in communication with the switching network. The control circuit may be configured for configuring the switching network to electrically short the plurality of conductive plates across the plurality of electrolyzer electrode assemblies when the system is in a fuel cell mode. The control circuit may also be configured for configuring the switching network to electrically short the plurality of conductive plates across the plurality of fuel cell electrode assemblies when the system is in an electrolyzer mode.

### BRIEF DESCRIPTION OF THE FIGURES

FIGS. 1 and 2 are exploded block diagrams of regenerative fuel cell/electrolyzer stacks according to various embodiments of the present invention;

FIG. 3 is a flow chart showing a process flow for operating a regenerative fuel cell/electrolyzer stack in an electrolyzer mode;

FIG. 4 is a flow chart showing a process flow for operating a regenerative fuel cell/electrolyzer stack in a fuel cell mode;

FIG. 5 is an exploded three dimensional view of a regenerative fuel cell/electrolyzer stack according to various embodiments of the present invention;

FIG. 6 is an exploded three dimensional view of a portion of a regenerative fuel cell/electrolyzer stack according to various embodiments of the present invention;

FIG. 7 is an exploded three dimensional view of a portion of a regenerative fuel cell/electrolyzer stack according to various embodiments of the present invention; and

FIG. 8 is a block diagram of a regenerative fuel cell/electrolyzer system according to various embodiments of the present invention.

### DESCRIPTION

As used herein and unless otherwise noted, the term “electrolyte” refers to any substance or material that is a conductor of ions. As used herein, the term “ionomer” refers to an electrolyte that includes a polymer.

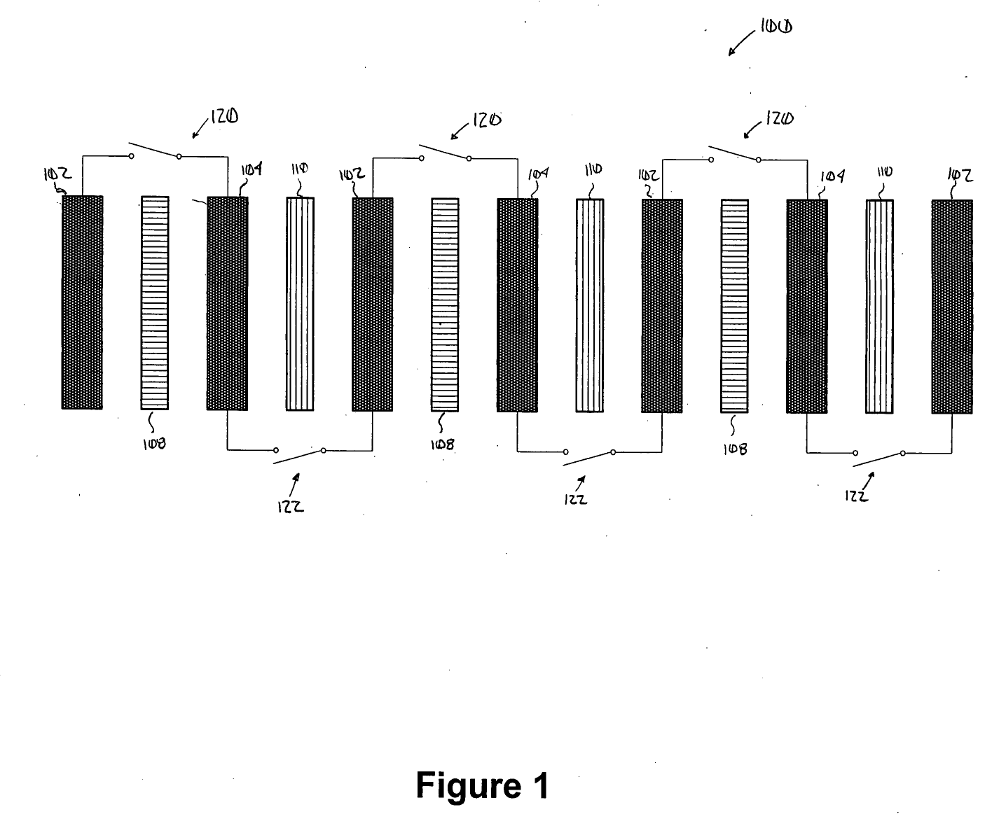

Referring to the figures, FIG. 1 shows an exploded block diagram of a regenerative fuel cell/electrolyzer stack 100 having a fuel cell mode and an electrolyzer mode according to various embodiments of the present invention. The stack 100 includes electrolyzer electrode assemblies 108 and fuel cell electrode assemblies 110 with common conductive plates 102, 104 positioned between therebetween. According to various non-limiting embodiments, the fuel cell electrode assemblies 110 and electrolyzer electrode assemblies 108 are interleaved. The conductive plates 102, 104 in various embodiments may, but need not be bi-polar, and may route reactants, products, coolants, conditioners and/or other substances to and/or from the electrode assemblies 108, 110. In one non-limiting embodiment, each conductive plate 102, 104 may route reactants and/or products to and/or from one electrolyzer electrode assembly 108 and one fuel cell electrode assembly 110.

The stack 100 may also include switch units 120 and 122 positioned to short conductive plates 102 and 104 to one another to configure the stack 100 for operation in fuel cell and electrolyzer modes. The switch units 120, 122 may be configured according to any suitable switching technology. In various non-limiting embodiments, the switch units 120, 122 may be implemented as a solid state circuit, for example, including one or more transistors. For example, the switch units 120, 122 may include a semi-conductor switching material that is part of the electrode assemblies 108, 110. Adjacent plates 102, 104 may be in physical contact with one another through semi-conductor switching contacts. This may allow switching to take place through the plane of the plates 102, 104 rather than in the plane of the plates 102, 104. In still other non-limiting embodiments, the switch units 120, 122 may include mechanical switches actuated manually or automatically, for example, by one or more solenoids.

The stack 100 may be configured to operate in a fuel cell or electrolyzer mode by shorting conductive plates 102, 104 across the set of electrode assemblies 108,110 that are not needed for the selected mode. For example, the stack 100 may be configured to operate in a fuel cell mode by closing switch units 120, which short conductive plates 102, 104 across electrolyzer electrode assemblies 108, rendering them electrically inactive. Conversely, the stack 100 may be configured to operate in an electrolyzer mode by closing switch units 122, which short conductive plates 102, 104 across fuel cell electrode assemblies 110, rendering them electrically inactive.

By utilizing common conductive plates 102, 104 for both fuel cell and electrolyzer operation, the stack 100 may avoid the weight and bulk problems associated with having distinct fuel cell and electrolyzer cells. At the same time, having separate fuel cell electrode assemblies 110 and electrolyzer electrode assemblies 108 may allow each of the assemblies 108, 110 to be optimized for its respective operation. It will be appreciated that the total number of conductive plates 102, 104, fuel cell electrode assemblies 110 and electrolyzer electrode assemblies 108 included in the stack 100 may vary depending on the power storage and output requirements of the particular application. Also, various embodiments may include unequal numbers of electrolyzer electrode assemblies 108 and fuel cell electrode assemblies 110.

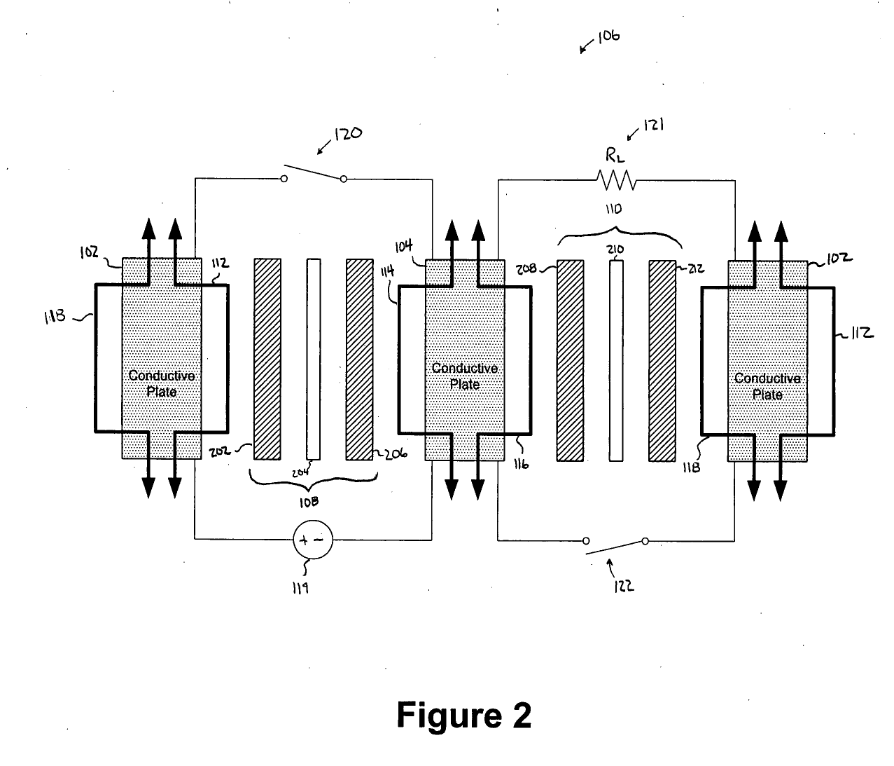

FIG. 2 shows a block diagram of a portion 106 of the regenerative fuel cell/electrolyzer stack 100 according to various embodiments showing one electrolyzer electrode assembly 108, one fuel cell electrode assembly 110 and surrounding conductive plates 102, 104. The fuel cell electrode assembly 110 may include a fuel cell cathode 208, a fuel cell anode 212 and a fuel cell electrolyte 210. When the stack 100 is operated in a fuel cell mode, the fuel cell electrode assembly 110 may drive a load resistance 121 as described in more detail below. It will be appreciated that the fuel cell electrode assembly 110 may be configured according to any suitable fuel cell type including, for example, a proton exchange membrane (PEM) or polymer electrolyte fuel cell, an alkaline fuel cell, a phosphoric acid fuel cell, a molten carbonate fuel cell, a solid oxide fuel cell, etc. The electrolyzer electrode assembly 108 may be configured to match the fuel cell electrode assembly 110.

The fuel cell cathode 208 and anode 212 may be made from any suitable suitable material including, for example, porous plates made of metal or another conductive material. The fuel cell electrolyte 210 may be any electrolyte suitable for use in a fuel cell application, and may be determined based on the type of fuel cell technology being implemented in a particular application. For example, in applications where the fuel cell electrode assembly 110 is configured according to PEM fuel cell technology, the fuel cell electrolyte 210 may be any suitable ionomer including, for example, a fluorinated sulfonic acid copolymer, such as the NAFION product available from DU PONT. In various non-limiting embodiments, the electrolyte 210 may be solid or liquid and in various embodiments, may be retained in a porous matrix material.

It will be appreciated that the fuel cell electrode assembly 110 may include various other components (not shown). For example, various gas diffusion media may manage the flow of hydrogen and oxygen at the electrodes 208, 212. One or more catalysts such as, for example, platinum, may be present on the surface of the electrodes 208, 212 to promote the fuel cell reaction. In one non-limiting embodiment, the electrodes 208, 212 may be made of platinum. Also, various seals, compression limiters, frames and other components may manage compression, thermal and electrical factors within the fuel cell electrode assembly 110.

The electrolyzer electrode assembly 108 may include an electrolyzer anode 202, an electrolyzer cathode 206 and an electrolyte 204. The electrolyzer anode 202 and cathode 206 may be made from any suitable conductive material including, for example, porous plates made of metal or other conductive materials. The electrolyte 204 may be any kind of electrolyte suitable for electrolyzer operation, such as an alkaline material or acid. The electrolyte 204 may be solid or liquid, and in various embodiments, may be retained in a porous matrix material. In one non-limiting embodiment, the electrolyte 204 may include a solid ionomer, or proton exchange membrane (PEM), forming a PEM type electrolyzer cell. The ionomer may be a fluorinated sulfonic acid copolymer such as, for example, the NAFION brand product available from DU PONT. When the stack 100 is operated in an electrolyzer mode, the electrolyzer electrode assembly 108 may be biased by a power supply 119 as described in more detail below. Like the fuel cell electrode assembly 110, the electrolyte electrode assembly 108 may include other components (not shown) including, for example, catalysts, gas diffusion media, seals, compression limiters, frames, etc.

Conductive plates 102, 104 may be constructed from any suitable electrically conductive material including, for example, carbon, graphite, any suitable metal, etc. It will be appreciated that the material of the conductive plates 102, 104 may be determined by the type of fuel cell and electrolyzer cells used. For example, when solid oxide cells are used, the conductive plates 102, 104 may not be made of metal. The conductive plates 102, 104 may perform various tasks within the stack 100 including, for example, managing the flow of reactants and products to and from the electrode assemblies 108, 110. Accordingly, the plates 102, 104 may include one or more flow paths 112, 114, 116, 118 for directing substances towards and away from the electrode assemblies 108, 110 including, for example, reactants, products, coolants, conditioners, etc. For example, conductive plates 102 may include an electrolyzer anode flow path 112 open to an electrolyzer anode 202 on a first major surface and a fuel cell anode flow path 118 open to a fuel cell anode 212 on a second major surface. Conductive plates 104 may include an electrolyzer cathode flow path 114 open to an electrolyzer cathode 206 on a first major surface and a fuel cell cathode flow path 116 open to a fuel cell cathode 208 on a second major surface. In various embodiments, and in various mode, reactants, products, coolants, conditioners, etc. may be directed in either direction through flow paths 112, 114, 116, 118.

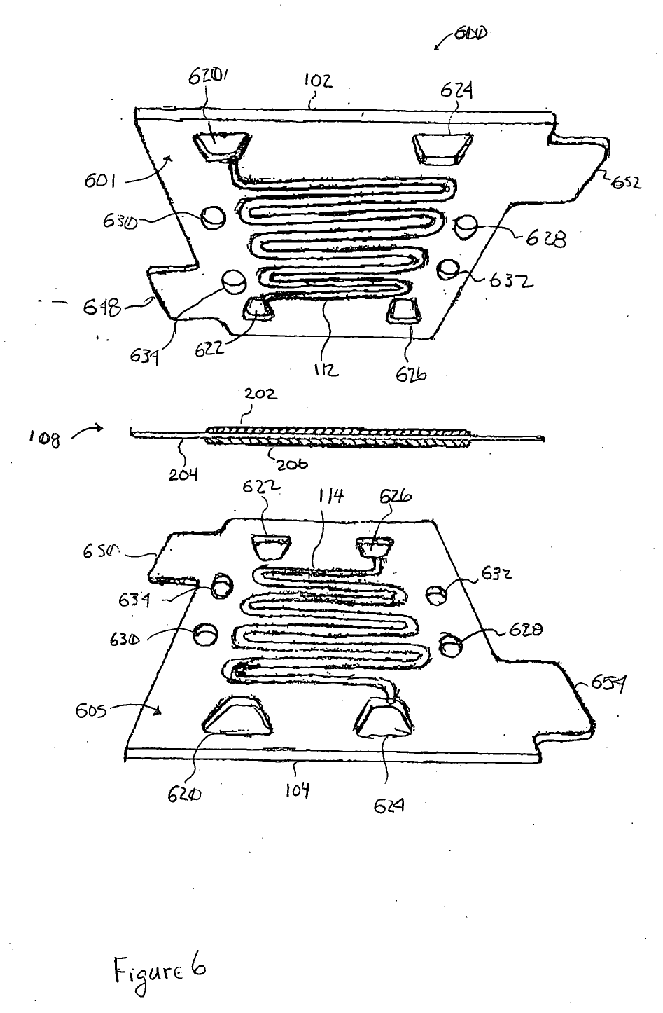

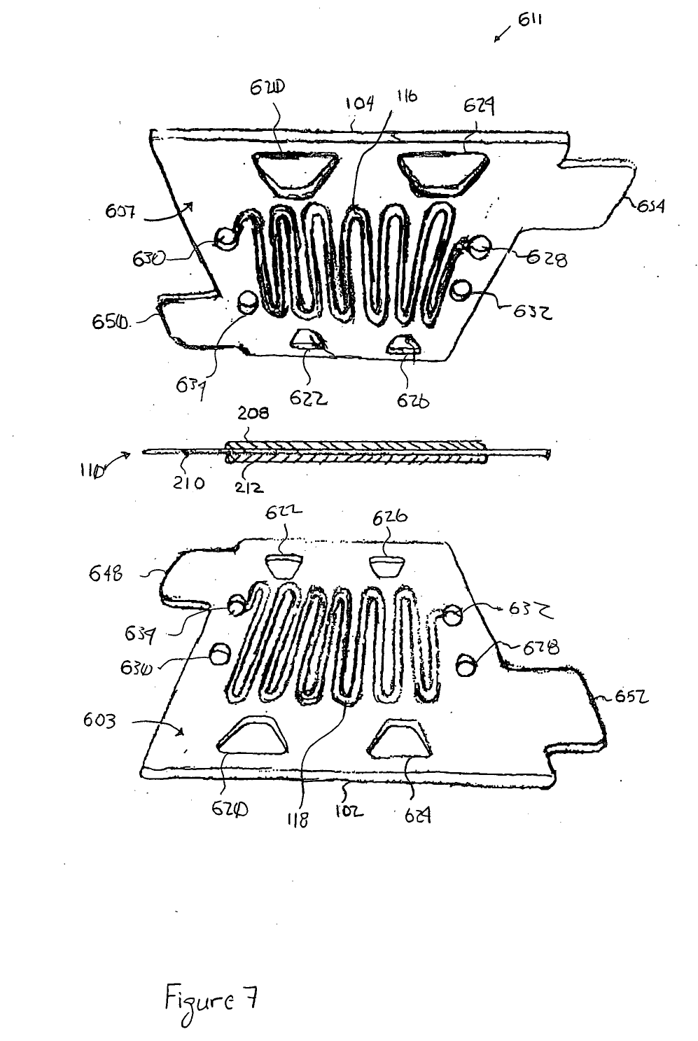

The various flow paths 112, 114, 116, 118 may take any suitable form. For example, flow paths 112, 114, 116, 118 may take the form of channels or grooves on the surface of the respective conductive plates 102, 104 or of the porous diffusion media or electrode. Grooves of the various flow paths 112, 114, 116, 118 may be fed by ducts (not shown in FIG. 2) as described below with reference to FIG. 6-7. It will be appreciated that flow paths 112, 114, 116, 118 may be optimized for use with the electrolyzer electrode assembly 108 or the fuel cell electrode assembly. For example, electrolyzer anode and cathode flow paths 112, 114 may be made from a hydrophilic material, as it is preferable to maintain adequate hydration of the electrolyzer electrode assembly 108. In contrast, fuel cell anode and cathode flow paths 118, 116 may include a hydrophobic material, as it is preferable to remove water from the fuel cell electrode assembly 110.

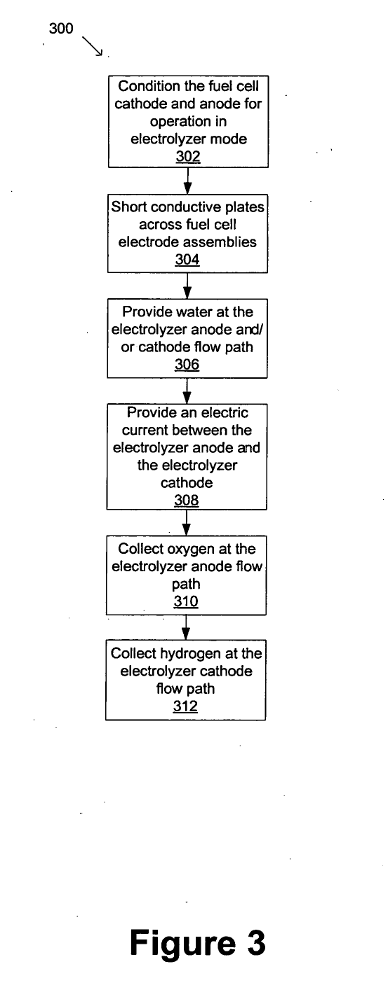

FIG. 3 is a flow chart illustrating a process flow 300 for operating the fuel cell/electrolyzer stack 100 in an electrolyzer mode according to various embodiments. At step 302, the fuel cell electrode assembly 110 may be conditioned for operation in an electrolysis mode. This may involve purging fuel cell reactants and products from the fuel cell anode flow path 118 and the fuel cell cathode flow path 116. In another non-limiting embodiment, conditioning species may be introduced to the fuel cell electrode assembly 110 via the fuel cell anode and cathode flow paths 118, 116. Exemplary conditioning species include nitrogen, inert gases, reactants, etc.

At step 304, conductive plates 102, 104 may be shorted across the fuel cell electrode assembly 110, for example, by closing switch unit 122. In various embodiments, the load resistance 121 may also be disconnected. At step 306, water may be provided at the electrolyzer anode flow path 112. Because the electrolyzer anode flow path 112 is open to the electrolyzer anode 202, water provided at the flow path 112 may come into contact with the electrolyzer anode 202. The water may encounter various intermediate components before reaching the electrolyzer anode 202, including, for example, diffusion media, catalyst layers, etc. In one non-limiting embodiment, water may also be provided at the electrolyzer cathode flow path 114. Because the electrolyzer cathode flow path 114 is open to the electrolyzer cathode 206, the water provided at the flow path 114 may come into contact with the electrolyzer cathode 206.

At step 308, an electric current may be provided between the electrolyzer anode 202 and the electrolyzer cathode 206. The current may be generated, for example, by power supply 119 (see FIG. 2). The power supply 119 may be any kind of apparatus for generating an electric current. For example, the power supply 119 may be a power grid, a solar cell, a wind or water turbine, a generator, etc. Although the power supply 119 is shown connected to only one electrolyzer electrode assembly 108, it will be appreciated that the power supply 119 may be connected to multiple electrolyzer electrode assemblies 108 included in the stack 100. In various non-limiting embodiments, the electrolyzer electrode assemblies 108 may be arranged in series or in parallel relative to one another, or any combination thereof

In response to the electric current, water provided to the electrolyzer anode 202 and or cathode 206 via the electrolyzer anode flow path 112 is split into hydrogen and oxygen. When PEM cells are used, the oxygen may continue to flow through the electrolyzer anode flow path 112 where it is collected at step 310. The hydrogen may be transported across the electrolyzer electrolyte 204 to the electrolyzer cathode 206 where it may be collected via the electrolyzer cathode flow path 114 at step 312. It will be appreciated that the steps of the process flow 300 may be performed in any suitable order or simultaneously.

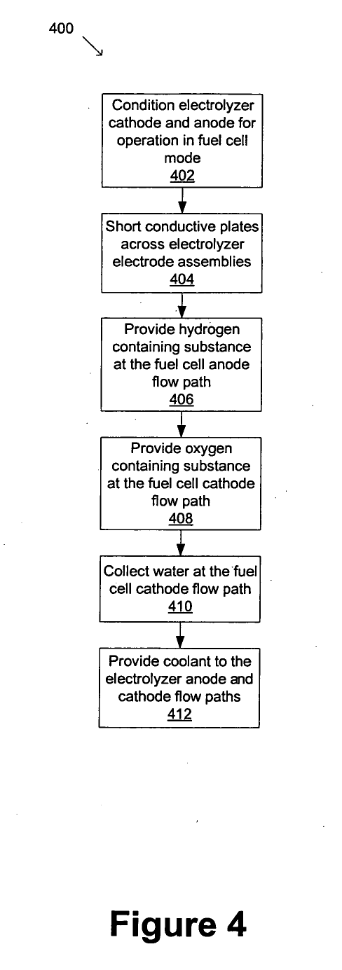

FIG. 4 is a flow chart illustrating a process flow 400 for operating the stack 100 in a fuel cell mode according to various embodiments. At step 402, the electrolyzer anode 202 and electrolyzer cathode 206 may be conditioned for operation in the fuel cell mode. This may involve purging reactants and products from the electrolyzer anode flow path 112 and electrolyzer cathode flow path 114.

At step 404, the conductive plates 102, 104 may be shorted across the electrolyzer electrode assembly 108, for example, by closing switch unit 120. In various non-limiting embodiments, the power supply 119 may also be disconnected. At step 406, a hydrogen containing substance may be provided at fuel cell anode flow path 118. The hydrogen containing substance may be any substance, compound, or solution including hydrogen such as, for example, hydrogen gas, a hydrogen rich gas, natural gas, etc. Because the fuel cell anode flow path 118 is open to the fuel cell anode 212, the hydrogen containing substance may come into contact with the fuel cell anode 212. In various embodiments the hydrogen containing substance may encounter one or more intermediate components between the fuel cell anode flow path 118 and the fuel cell anode 212 including, for example, gas diffusion media, catalyst layers, etc.

At step 408, an oxygen containing substance may be provided at the fuel cell cathode flow path 116. The oxygen containing substance may be any substance, compound or solution including oxygen, such as, for example, oxygen gas, an oxygen rich gas, air, etc. Because the fuel cell cathode flow path 116 is open to the fuel cell cathode 208, the oxygen containing substance may come into contact with the fuel cell cathode 208. In various embodiments, the oxygen containing substance may, like the hydrogen containing substance, encounter one or more intermediate components between the fuel cell cathode flow path 114 and the fuel cell cathode 208 including gas diffusion media, catalyst layers, etc.

When the hydrogen containing substance is provided to the fuel cell anode 212 and the oxygen containing substance is provided to the fuel cell cathode 208, hydrogen and oxygen present may chemically combine in a fuel cell reaction producing electric current, water, and heat. Electric current may be generated between the fuel cell cathode 208 and anode 212, and may drive load resistance 121 (see FIG. 2). The load resistance 121 may represent any device or system commonly powered by electricity including, a motor, a light, a computer, etc. In will be appreciated that in various embodiments, the load resistance 121 may be driven by a plurality of fuel cell electrode assemblies 110 arranged in series or parallel.

Water may be generated at the fuel cell cathode 208 and transported away from the cathode 208 along the fuel cell cathode flow path 116, where it may be collected at step 410. At least a portion of the heat generated by the fuel cell reaction may be dissipated, for example, into the conductive plates 102, 104. At step 412, a coolant substance may be provided to the electrolyzer anode flow path 112 and/or the electrolyzer cathode flow path 114 within conductive plates 102, 104. The coolant substance may be circulated to carry heat away from the stack 100. The coolant substance may be an aqueous solution, air, refrigerant, or any other suitable substance. It will be appreciated that the steps of the process flow 400 may be performed in any suitable order or simultaneously.

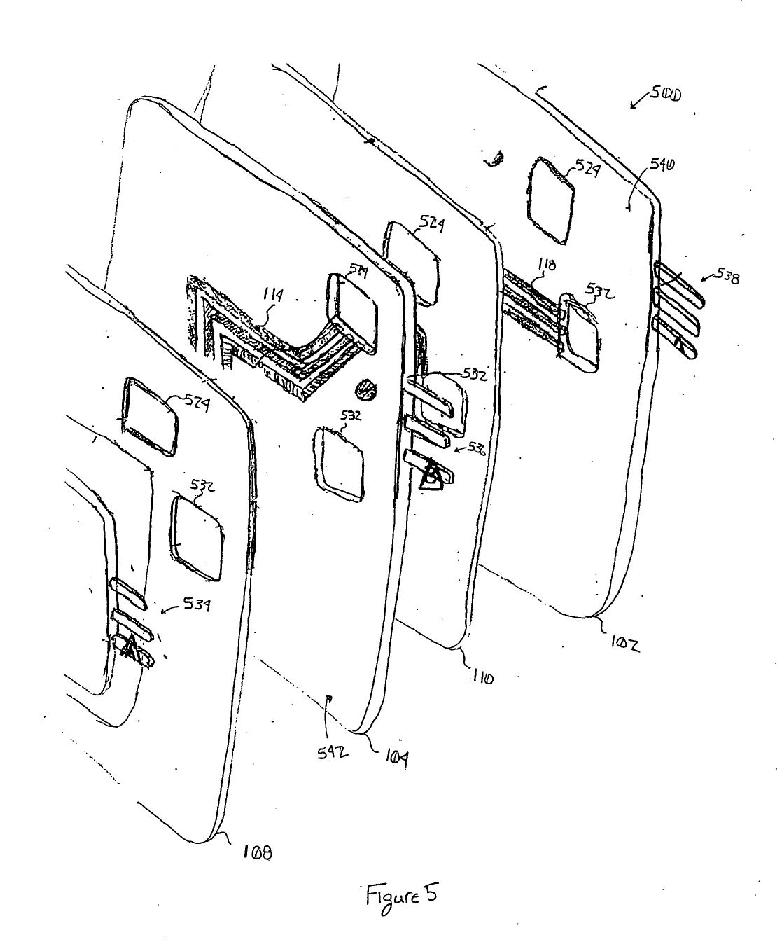

FIGS. 5-7 show exemplary physical embodiments of conductive plates 102, 104 and electrode assemblies 108, 110 that may be included in the stack 100 according to various embodiments. FIG. 5 shows an exploded stack portion 500 including an electrolyzer electrode assembly 108, a fuel cell electrode assembly 110, and conductive plates 102 and 104. An electrolyzer cathode flow path 114 is shown as a series of grooves on a first face 542 of the conductive plate 104. Accordingly, flow path 114 may be open to the electrolyzer cathode (not shown) present at electrolyzer electrode assembly 108. The flow path 114 may terminate at a duct section 524 present in the conductive plate 104. Each of the other components 102, 108, 110 of the stack portion 500 may include corresponding duct sections 524. When the components 102, 104, 108, 110 are assembled, the duct sections 524 of each component may align, forming one duct running along the stack portion 500 and allowing outside access to the electrolyzer cathode flow path 114.

A fuel cell anode flow path 118 is shown in FIG. 5 as a series of grooves located on a face 540 of conductive plate 102. The flow path 118 may be open to a fuel cell anode (not shown) present at the fuel cell electrode assembly 110. Also, the flow path 118 may terminate at duct section 532. Corresponding duct sections 532 may be present on all of the shown components 102, 104, 108, 110 and may form a duct when the stack portion 500 is assembled, similar to duct sections 524 as described above.

FIG. 5 also shows various posts 534, 536, 538 present on components 108, 104 and 102. Posts 534, shown in the electrolyzer electrode assembly 108, may be connected to the anode and cathode (not shown) of the electrolyzer electrode assembly 108, and may be used to connect a power supply to the electrolyzer electrode assembly 108. Posts 536 and 538 may be used to short respective conductive plates 104 and 102 to surrounding conductive plates depending on the stack portion's mode of operation. For example, when the stack portion 500 is configured to operate in a fuel cell mode, plate 104 and 102 may be shorted by posts 536 and 538, thus rendering electrolysis electrode assembly 110 electrically inactive.

FIG. 6 shows an exploded diagram of a stack section 600, according to various embodiments, including conductive plates 102, 104 and electrolyzer electrode assembly 108 including anode 202, cathode 206 and electrolyte 204. Conductive plate 102 may include shorting posts 648 and 652. Shorting posts 648 and 652 may be used to short conductive plate 102 to adjacent conductive plates during the operation of the stack. For example, shorting posts 648, 652 may form a portion of switch units 120, 122.

A first face 601 of conductive plate 102 may include an electrolyzer anode flow path 112. The electrolyzer anode flow path 112 is shown as a groove cut in the face 601. Accordingly, the electrolyzer anode flow path 112 may be open to the electrolyzer anode 202. Electrolyzer anode flow path 112 is shown terminating at duct sections 620 and 622. Other electrolyzer anode flow paths (not shown) on other conductive plates (not shown) within the stack may also terminate at duct sections 620 and 622 located in the other conductive plates. Corresponding duct sections 620 and 622 may be included in all of the components of the stack section 600. When the stack section 600 is assembled, duct sections 620 and 622 may form input/output ducts for all electroyzer anode flow paths in conductive plates within the stack. The conductive plate 102 may also include input/output duct sections 624 and 626 for the electrolyzer cathode flow path 112 as well as duct sections 628, 630, 632 and 634, serving as input and outputs for other flow paths discussed in more detail below.

A first face 605 of conductive plate 104 is also shown in FIG. 6. The first face 605 includes electrolyzer cathode flow path 114, which may be a groove in the face 605 open to electrolyzer.cathode 206 as shown. The electrolyzer cathode flow path 114 may terminate at duct sections 624 and 626. In addition, the first face 605 of the conductive plate 104 may include duct sections 620, 622, 628, 630, 632 and 634. Shorting posts 650 and 654 may be used to short conductive plate 104 to adjacent conductive plates during operation of the stack.

FIG. 7 shows an exploded diagram of a stack portion 611 including embodiments of conductive plates 102, 104 as well as fuel cell electrode assembly 110 including cathode 208, anode 212 and electrolyte 210. A second face 607 of conductive plate 104 is shown including fuel cell cathode flow path 116 shown as a groove in the face 607 open to the fuel cell cathode 208. Fuel cell cathode flow path 116 may terminate at duct sections 628 and 630. A second face 603 of conductive plate 102 is also shown including a fuel cell anode flow path 118 shown as a groove open to the fuel cell anode 212. The fuel cell anode flow path 118 may terminate at duct section 632 and 634.

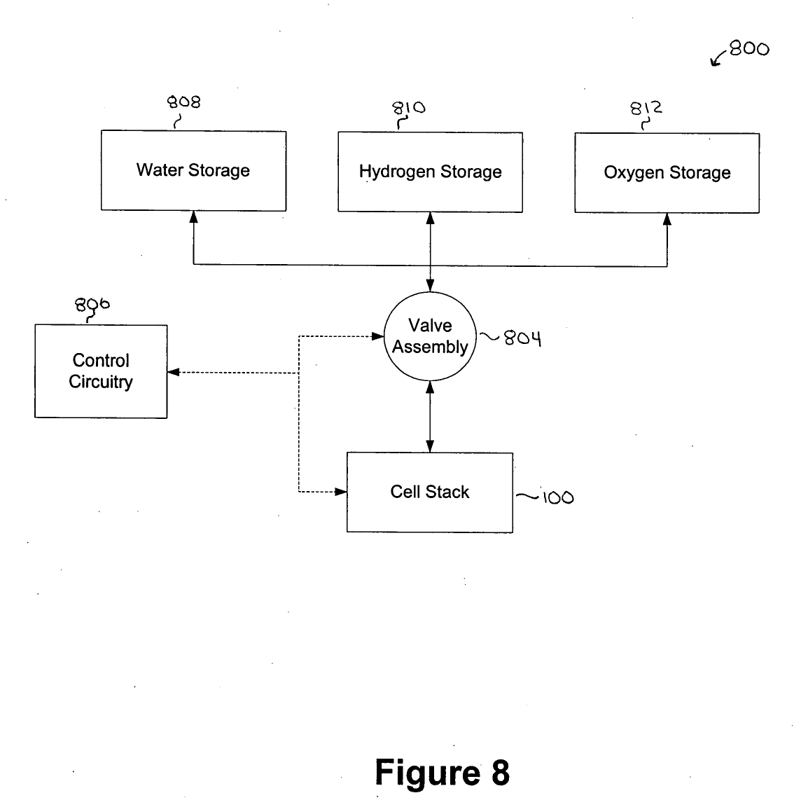

FIG. 8 shows a system 800 for operating the regenerative fuel cell/electrolyzer stack 100 according to various embodiments of the invention. It will be appreciated that the system 800 is but one embodiment of a system utilizing regenerative fuel cell/electrolyzer stacks according to various embodiments of the present invention. Other systems may exclude some of the components shown with system 800, or include additional components.

The system 800 may include a cell stack 100, a valve assembly 804, reactant/product storage 808, 810, 812 and control circuitry 806. The control circuitry may include any kind of control devices known in the art, including, for example, logic circuitry, a computer system, etc. Control circuitry 806 may operate the valve assembly 804 to provide reactants and collect products from the cell stack 100 during fuel cell and electrolyzer operation, for example, according to the process flows 300, 400 described above.

The control circuitry 806 may also configure the cell stack 100 for operation alternatively in a fuel cell mode and an electrolyzer mode. When the cell stack 100 is operated in fuel cell mode, the control circuitry 806 may configure the cell stack 100 for fuel cell operation, for example, by shorting common conductive plates across the electrolyzer electrode assemblies. The control circuitry 806 may also configure the valve assembly 804 to provide hydrogen containing substance and oxygen containing substance to the stack 100 from hydrogen storage 810 and oxygen storage 812, respectively. The valve assembly 804 may be further configured to remove water to water storage 808. When the system 800 is operated in electrolyzer mode, the control circuitry 806 may configure the cell stack 100 for electrolyzer operation, for example, by shorting common conductive plates across the fuel cell electrode assemblies. The control circuit 806 may also configure the valve assembly 804 to provide water to the stack 100 and remove the products, hydrogen and oxygen.

While several embodiments of the invention have been described, it should be apparent that various modifications, alterations and adaptations to those embodiments may occur to persons skilled in the art with the attainment of some or all of the advantages of the present invention. For example, although portions of the disclosure describe elements specific to PEM fuel cell and electrolyzer configurations, it will be appreciated that stacks according to various embodiments may utilize other fuel cell and electrolyzer configurations using other fuels, ions, electrolytes, etc. The present disclosure, therefore, is intended to cover all such modifications, alterations and adaptations without departing from the scope and spirit of the present invention as defined by the appended claims.

We claim:

1. A regenerative fuel cell/electrolyzer stack comprising:
a fuel cell electrode assembly comprising first and second fuel cell electrodes, and a fuel cell electrolyte;
an electrolyzer electrode assembly comprising first and second electrolyzer electrodes; and
a conductive plate positioned between the fuel cell electrode assembly and the electrolyzer electrode assembly, the conductive plate comprising:
a first surface facing the first fuel cell electrode, wherein the first surface comprises at least one flow path open to the first fuel cell electrode;
a second surface facing the first electrolyzer electrode, wherein the second surface comprises at least one flow path open to the first electrolyzer electrode.

2. The stack of claim 1, further comprising:
a second fuel cell electrode assembly comprising third and fourth fuel cell electrodes and a second fuel cell electrolyte;
a second conductive plate positioned between the electrolyzer electrode assembly and the second fuel cell electrode assembly, the second conductive plate comprising:
a first surface facing the second electrolyzer electrode, wherein the second surface comprises at least one flow path open to the second electrolyzer electrode; and
a second surface facing the third fuel cell electrode, wherein the second surface comprises at least one flow path open to the third fuel cell electrode.

3. The stack of claim 1, wherein the fuel cell electrolyte comprises an ionomer.

4. The stack of claim 3, wherein the fuel cell electrolyte comprises a Proton Exchange Membrane (PEM).

5. The stack of claim 3, wherein the fuel cell electrolyte comprises a fluorinated sulfonic acid copolymer.

6. The stack of claim 1, further comprising a gas diffuser positioned between the first fuel cell electrode and the conductive plate.

7. The stack of claim 1, wherein the electrolyzer electrode assembly further comprises an ionomer positioned between the first and the second electrolyzer electrodes.

8. The stack of claim 1, wherein the at least one flow path open to the first fuel cell electrode comprises a channel on the first surface of the conductive plate.

9. The stack of claim 1, wherein the at least one flow path open to the first fuel cell electrode comprises a hydrophobic surface.

10. The stack of claim 1, wherein the at least one flow path open to the first electrolyzer electrode comprises a hydrophilic surface.

11. In a regenerative fuel cell/electrolyzer stack comprising: a fuel cell electrode assembly comprising a fuel cell cathode, a fuel cell anode and a fuel cell electrolyte; an electrolyzer electrode assembly comprising an electrolyzer cathode and an electrolyzer anode;
a first conductive plate positioned between the fuel cell electrode assembly and the electrolyzer electrode assembly; a second conductive plate positioned opposite the fuel cell electrode assembly from the first conductive plate; and a third conductive plate positioned opposite the electrolyzer electrode assembly from the first conductive plate, a method of operating the regenerative fuel cell/electrolyzer stack, the method comprising:
providing an electrical connection between the first and third conductive plates;
providing a hydrogen-containing substance to the fuel cell anode via a fuel cell anode flow path in the first conductive plate;
providing an oxygen-containing substance to the fuel cell cathode via a fuel cell cathode flow path in the second conductive plate.

12. The method of claim 1 1, further comprising providing a coolant via a second flow path in the first conductive plate and a first flow path in the third conductive plate.

13. The method of claim 11, further comprising:
removing the electrical connection between the first and third conductive plates;
providing an electrical connection between the first and second conductive plates;
providing an electric current between the electrolyzer anode and the electrolyzer cathode;
providing water to the electrolyzer anode via a second flow path in the first conductive plate and a flow path.

14. The method of claim 13, further comprising providing water to the electrolyzer cathode via a first flow path in the third conductive plate.

15. The method of claim 13, further comprising providing species for conditioning the electrolyte to the fuel cell anode flow path in the first conductive plate and the fuel cell cathode flow path in the second conductive plate.

16. The method of claim 15, wherein the species include at least one of the group consisting of an inert gas and a reactant.

17. The method of claim 16, wherein the reactant is selected from the group comprising a hydrogen containing substance and an oxygen containing substance.

18. The method of claim 13, further comprising providing a vacuum at the fuel cell anode flow path in the first conductive plate and the fuel cell cathode flow path in the second conductive plate.

19. A regenerative fuel cell system, the system comprising:
a plurality of fuel cell electrode assemblies;
a plurality of electrolyzer electrode assemblies, positioned such that at least a portion of the electrolyzer electrode assemblies and at least a portion of the fuel cell electrode assemblies are interleaved;
a plurality of conductive plates, wherein at least one conductive plate is positioned between one of the plurality of fuel cell electrode assemblies and one of the plurality of electrolyzer electrode assemblies;
a switching network comprising a plurality of switches coupled to the plurality of conductive plates;
a control circuit in communication with the switching network and configured for:
configuring the switching network to electrically short the plurality of conductive plates across the plurality of electrolyzer electrode assemblies when the system is in a fuel cell mode; and
configuring the switching network to electrically short the plurality of conductive plates across the plurality of fuel cell electrode assemblies when the system is in an electrolyzer mode.

20. The fuel cell system of claim 19, further comprising:
a hydrogen storage unit;
an oxygen storage unit;
a water storage unit; and
a valve assembly fluidically coupled to the hydrogen storage unit, the oxygen storage unit and the water storage unit, wherein the control circuit is further configured for configuring the valve assembly to provide a hydrogen containing substance from the hydrogen storage unit and an oxygen containing substance from the oxygen storage unit to the plurality of electrode assemblies when the fuel cell system is in the fuel cell mode; and for configuring the valve assembly to provide water from the water storage unit to the electrolyzer electrode assemblies when the fuel cell system is in the electrolyzer mode.

21. The fuel cell system of claim 19, wherein the number of fuel cell electrode assemblies and electrolyzer electrode assemblies is unequal.
